(19) United States
(12) Patent Application Publication
(10) Pub. No.: US 2006/0163880 A1
(43) Pub. Date: Jul. 27, 2006

(54) Offshore wind park

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/504,546

(22) PCT Filed: Feb. 12, 2003
(86) PCT No.: PCT/EP03/01351

§ 371 Date: May 18, 2005

(30) Foreign Application Priority Data
Feb. 16, 2002 (DE) 102 06 495.4

(51) Int. Cl. F03D 9/00; H02P 9/04

(52) U.S. Cl. 290/44

(57) ABSTRACT

The present invention relates to wind farms, so called, comprising at least two wind turbines, and in particular to offshore wind farms. In order to provide a wind farm in which transport between separate wind turbines can be effected more safely and with less dependence on weather, at least one cable connection is provided between at least two of the wind turbines of a wind farm, and a vessel is disposed on said cable connection.

### BACKGROUND OF THE INVENTION

1. Field of the Invention

The present invention relates to a wind farm comprising at least two wind turbines and in particular to an offshore wind farm.

2. Description of the Related Art

The wind turbines in wind farms are spaced from one another at such distances that any collision of blades is securely avoided even when the wind turns direction, and the effects of one wind turbine on another as a result of changing air flow conditions are kept as small as possible. The distance between wind turbines is dependent on the radius of the circle swept by the rotor of a wind turbine and, with rotor diameters in excess of 100 m now possible at the current state of technological development, the distance between wind turbines will increase still further due to the even larger dimensions of new wind turbines.

Depending on location and size, each wind turbine requires maintenance and the elimination of any malfunctions that may arise. To do this, personnel and material must be transported to the wind turbine.

It is relatively easy to bring personnel and material to every wind turbine on land-based wind farms, whereas in the case of offshore wind farms this involves much greater effort and expense. The process can be simplified by bringing people and goods, such as tools, spare parts, etc. to one place only, rather than having to call at each separate wind turbine on a wind farm.

The problem which then arises is that of distributing landed goods, or generally of transporting goods and/or people between the wind turbines of a wind farm, and particularly of an offshore wind farm.

Based on the premise that a wind farm has a central landing place where all goods and persons arrive or depart, the latter must accordingly be transported between the separate wind turbines of the wind farm.

One characteristic of offshore wind farms is that the weather there is always rougher than on land. Winds can blow unobstructed and quickly reach high speeds.

Furthermore, waves of greater or lesser height must be expected at all times. Therefore, transporting goods and ferrying people to the separate wind turbines is not only unpleasant in many cases, but may even involve a considerable degree of risk, and at high wind forces is practically impossible.

### BRIEF SUMMARY OF THE INVENTION

One object of the present invention is therefore to provide a wind farm in which the separate wind turbines of the wind farm can be reliably serviced, and in which such servicing can still be performed even when rough weather conditions prevail for several days.

This object is achieved according to the invention with a wind farm having the features of claim 1. Advantageous embodiments are described in the subclaims.

The wind farm according to the invention comprises not only a plurality of wind turbines, but also has a separate offshore platform on which people responsible for servicing the wind farm can live and work. Such an offshore platform must presumably be equipped in such a way that persons staying there can also remain and take care of themselves there for several weeks at a time. This requires, therefore, that the offshore platform be fitted with appropriate “social” facilities, i.e., sleeping quarters, mess rooms, kitchen, recreation rooms, etc.

If, at higher wind forces, operating personnel has to cross to one turbine or the other in order to carry out maintenance or servicing, said wind turbines can preferably be reached via the cableway connection running from the platform. This obviates the need for any kind of transportation by ship or helicopter, while also enabling the maintenance and servicing material to be transported at the same time via the cableway connection.

In another embodiment of the invention, the platform can also be equipped with an electrolysis plant so that water can be converted to its hydrogen and oxygen constituents using the electricity generated by the wind turbine. The hydrogen produced in this way, and preferably also the oxygen, is stored in appropriate gas tanks (on the platform) and can then be transported to land by ship or pipeline.

In certain circumstances, such production of hydrogen and oxygen can make particular sense if fuel cell drives for vehicles become established, because in such a case there will be a very high demand for hydrogen, which can be generated on the high seas with the invention, without said production posing a hazard in any way for facilities on land, such as buildings, residential areas, etc.

If necessary, it is possible to provide several platforms instead of just one, in such a way that, in addition to a residential platform, there is also a “hydrogen production platform”. In the event of an accident on the production platform, the personnel still has the chance to withdraw to the safety of the residential platform.

In such a case, the separate platforms should, of course, be connected to each other with a suitable cableway connection.

The cableway connection is usually fitted with a motoric drive. For safety reasons, it is also advantageous if cableway transport is still possible when a power failure has occurred. Such a manual drive could be provided in the form of suitable facilities that can be operated with human power.

In the cableway or cable connection, the cable is preferably spanned at such a height that it neither impinges on the rotor diameter of the wind turbine nor touches the crests of waves, such than ships are unable to collide with the cable connections even when the waves are high.

A deflection member for the cable connection can be provided on each wind turbine and on each platform, such that the cable connection is spanned as an endless cable loop between the deflection members and the gondola is fixedly connected to the cable connection. By this means, the gondola can be driven in the desired direction by moving the cable connection, and the structure is kept very simple.

When there are two wind turbines connected to each other, the cable connection travels around the deflection member at each wind turbine and back to the other wind turbine.

When the cable connection connects at least three wind turbines with each, the deflection member on the middle wind turbine serves as a support, and the cable connection is guided onwards to the respective outer wind turbine.

The cable connection can be moved by means of a motor, and preferably by an electrically driven motor. This is particularly advantageous, because electrical energy is generated in the wind farm and is therefore readily available, thus obviating the need to transport other energy carriers, such as fuel. Electric motors can also be controlled in a simple manner.

The cable connection suitably comprises a main cable and a traction cable. Although the gondola is mounted on the main cable, it is able to travel in relation to said main cable. The traction cable is attached to the gondola. When the traction cable is pulled in the desired direction of travel, the gondola moves along the main cable in the desired direction. This traction on the traction cable can be provided by a motor. Electrical energy is advantageously used as the drive energy.

The deflection member preferably comprises two independently rotatable deflection pulleys, whereby the main cable is guided over one roller and the traction cable over the other roller. The traction cable can be configured as a circulating endless cable loop, whereas the main cable can be provided only once along the stretch travelled by the gondola. Due to the endless traction cable, it is sufficient to have a reversible drive for the traction cable in order to drive the gondola in the desired direction, and one can dispense with any reeling devices for the traction cable at the two ends thereof.

In one particularly preferred embodiment of the invention, the gondola moves along the main cable under its own power. A motoric drive and preferably an electromotoric drive can be provided for this purpose, whereby the store of energy for driving the motor is provided in an energy storage means in the gondola, for example in an accumulator.

A manual drive may be provided as an alternative to the motoric drive, or as a supplementary emergency drive so that the gondola can be moved in emergency operation even when there is a failure of the motor or the energy store.

In a particularly preferred embodiment of the invention, the drive energy is supplied via the cable connection, the main cable, the traction cable and/or a separate conductor line when the gondola is driven electrically. By this means, control signals can also be transmitted to the gondola and/or a tower by remote control, for example to control the drive motor or a winch or the like.

In a preferred development of the invention, telematics data, for example, are transmitted via the electrical connection to a central facility or to several wind turbines. Furthermore, it is possible via the cable connection to process the communications, with each other and with the gondola, of all the wind turbines in the wind farm between which the cable car is provided.

In an alternative embodiment of the invention, these communications, that is to say, for example, the transmission of telematics data, control signals, etc. between separate wind turbines on the wind farm and/or the gondola, can be effected at least in part by wireless transmission.

The cable connection can be structured in different ways. A simple structure is based on the principle of a chain, in which all wind turbines are connected to each other by the cable connection “like beads on a chain”. In this structure, the cable connection is a single continuous cable connection that connects at least some of the wind turbines in a predefinable series with each other.

However, the wind turbines may also be positioned in several rows, for example in three rows, and the cable connection follows, for example, a path in the shape of the letter “S” between the wind turbines to connect the wind turbines with each other.

An alternative variant of the cable system is a star-shaped arrangement of the cable connection, starting from a central facility representing, for example, a central landing place, so that all other wind turbines can be reached by the shortest possible path.

Another variant is a networked cable system that not only provides shortest possible connections from a central wind turbine to the other wind turbines, but also forms relatively short stretches between all the wind turbines.

In order to keep the horizontal displacement of the gondola on the cable connection low while the gondola is travelling between the wind turbines of a wind farm, or to prevent such displacement within certain limits, the wind farm according to the invention has, in a preferred development, a holding cable that is provided at a predefined vertical distance parallel to the cable connection. The distance is dimensioned in such a way that the gondola is guided between the cable connection and the holding cable. In this arrangement, the cable connection is preferably above the gondola, and the holding cable is below the gondola.

In a particularly advantageous development of the invention, one (upper) part of the endless cable loop in a cable connection configured as an endless loop can carry the gondola, while the other (lower) part of the endless cable loop performs the function of the holding cable.

In an alternative embodiment, a flywheel mass rotating about a vertical axis is used to stabilize the gondola. Said flywheel mass is driven by a motor and acts as a gyroscope to counter any horizontal displacement of the gondola.

Preferably, each wind turbine of the wind farm has a closeable door in its tower. Said door is generally located at the height at which the gondola reaches the wind turbine. This enables loading activities to be performed without having to overcome a difference in height.

In another preferred development, the wind turbines and the gondola have a locking device that permits the loading and unloading position of the gondola to be prescribed, such that swinging movements of the gondola relative to the tower of the wind turbine are prevented when the gondola is in said position. The locking device is preferably configured in such a way that one part of the locking device is provided close to the door on the tower of the wind turbine, and the other part at a suitable position on the gondola. A particularly preferred embodiment is one in which the locking device is a two-point locking device, in order to avoid the formation of a pivotal point that occurs when locking operates at one point only.

Preferably, said locking device can function electromagnetically and be switched on and off by operating a switch inside the tower and/or from the gondola. This enables convenient and secure handling without the risk of injury as a result of a swinging gondola that may, for example, collide with the tower due to wind action.

In one preferred development of the invention, the locking device can be remotely controlled, and it is particularly preferred for it to be remotely controllable from the gondola so that manual operation can be avoided. By this means, the latent risk of injury when operating the locking device is further reduced.

A particularly preferred embodiment is one in which a cover of substantially horizontal extension is mounted above the opening on at least one wind turbine, said cover bearing a protective wall extending substantially vertically and at a predefined distance parallel to the cable connection. By means of the cover and the protective wall, which enclose a predefined angle, a protective roof is formed that protects the gondola when in the area of the opening as well as the opening itself against weather. The gondola and the opening are protected by the tower itself, on the one hand, and by the protective roof, on the other, such that the gondola is shielded against the wind and is not pushed against the tower.

If the protective roof is made long enough, displacement of the gondola and hence a potential collision with the tower can be avoided even when the wind or wind vectors are transverse to the direction in which the gondola is travelling.

The horizontal spacing between the outer ends of the first protective wall and the tower is preferably greater than the horizontal spacing to the central portion of the protective wall. In this way, collisions between the gondola and the protective wall are prevented even when the gondola is horizontally displaced towards the protective wall, for example by cross winds.

In one preferred development of the invention, additional protective walls can be attached to the tower on both sides of the opening parallel to the first protective wall and at the same height, said additional walls extending the area in lee of the tower such that a wind vector transverse to the direction in which the gondola is travelling does not push the latter against the outer protective wall. The horizontal distance between the protective walls at the tower can be substantially equal to the width of the gondola and enlarge towards the lateral ends of the protective walls, such that a horizontal displacement of the gondola in the entry area between the protective walls does not lead to collisions between the gondola and one of the protective walls.

The gondola itself can preferably be fitted with elastic coating at each of the corners on the lower portion of the gondola cabin, and hence at those points that will be affected first in the event that a collision with other facilities of the wind farm occurs as a result of the gondola being horizontally displaced. On the one hand, said coatings dampen any collision that might occur, thus preventing damage occurring to the gondola and other facilities of the wind farm, and on the other hand they serve as buoyancy aids to keep the gondola buoyant in the event of an accident.

At the same time as, or in place of the elastic coating on the gondola, such a coating may also be provided on the protective walls, especially in the entry area and at a height at which a horizontally displaced gondola first collides with the protective wall.

A particularly preferred embodiment is one in which a first gangboard is provided at the second protective wall, said gangboard having a retention facility, such as a railing, all around it. In one advantageous development of the invention, the gangboard extends over the entire length of the protective wall and is attached in such a way that it can be reached from the opening.

By this means, the outer side of the gondola can be reached in order to perform repair work and/or maintenance and cleaning work, for example. If the second protective wall is present, the gangboard can be delineated on one side by said protective wall, and a retention facility can be dispensed with there.

It is particularly preferred to provide a second gangboard parallel to the first on the first protective wall. Said second gangboard, too, has a retention facility on the sides which are not adjacent to the first protective wall.

As a further preferred embodiment, a transverse gangboard can be provided at at least one outer end of the first and second gangboards, wherein said transverse gangboard bridges the gap between the substantially parallel first and second gangboards.

To enable unobstructed entry and exit of the gondola, the transverse gangboard can be pivotably coupled at one of its ends and pivoted upwards about its pivot axis in order to clear the way for the gondola to pass through. In one advantageous development of the invention, such transverse pivotable gangboards are coupled at both ends of the first or the second gangboard, thus enabling all sides of the gondola to be reached from the outside.

The gap between one transverse gangboard and the other is preferably selected so that it is substantially equal to the relevant dimensions of the gondola. In one particularly preferred development of the invention, at least one of the transverse gangboards is slideable along its pivotal axis, such that the distance between the transverse gangboards can be altered and hence adjusted to the respective requirements.

On at least one wind turbine tower, a hoisting apparatus can be provided, preferably under the protective roof, said hoisting device enabling the handling of heavy freight, on the one hand, and, on the other hand, the handling of the gondola and gondola parts, for example for repairs. By means of such a hoisting apparatus, provided it is designed for an appropriate load, the entire gondola can be hoisted so that the underside of the gondola can be reached from the gangboard for repair, maintenance and cleaning purposes.

In one alternative embodiment of the invention, a suitably mounted single- or multi-part working platform can be provided in place of gangboards in order to reach the outer sides of the gondola. To this end, the area of the working platform can have a minimum size that enables all sides of the gondola to be accessed from the outside.

In another alternative embodiment of the invention, a working cage or a crown safety platform can be provided, wherein said cage or platform can be moved and/or pivoted such that the outer sides of the gondola can be reached. The crown safety platform, like the working platform, is enclosed on all sides by a retention facility in order to prevent any unintentional fall from the platform or cage on the part of personnel working thereon.

In one particularly preferred embodiment of the invention, the door is larger than the cross section of the gondola, and the cable system extends into the tower of the wind turbine. This is achieved by having at least one set of points at each tower along the cable connection. In this way, the gondola can travel through the opened door in the tower and be loaded and/or unloaded therein regardless of weather conditions.

A closed gondola provides for transportation of people and goods in such a manner that they are substantially protected against the weather. In one particularly preferred development of the invention, the gondola is configured so that it has a closeable exit opening through which the guide with which the gondola is suspended from the cable connection and guided can be reached.

In order to avoid the loss of the gondola in the event of it falling from the cable, the gondola is preferably designed to be buoyant, and can dispose of signalling means such as signal guns, flares or the like, as well as buoyancy aids such as automatic self-inflating float rings. These buoyancy aids increase the buoyancy of the gondola so that it remains buoyant even when loaded. In one preferred development of the invention, the gondola has righting aids that at least make it more difficult for the gondola to overturn, or indeed prevent it from doing so.

In order to effect monitoring of operation, or at least semi-automatic control of the cable car system, a central control device as well as a plurality of sensors and/or actuators are provided. The sensors and/or actuators can be connected to the central control device via an interface.

By means of sensors connected thereto, the central control device can thus identify, on the one hand, certain operating parameters and states, for instance the position of the gondola, its operating speed, the horizontal displacement, the weight of the gondola, the rotational speed of a flywheel mass, the amount of energy stored, motor operational data, the openings in the towers (closed, open, . . . ), etc. Of course, telematics data can also be captured by sensors in the machine house of a wind turbine and subsequently processed.

By means of the actuators provided, the central control unit is able to influence operating parameters and states. This can involve, for example, controlling the locking device between the gondola and the tower, depending on the position of the gondola relative to the tower, or controlling the lighting under the protective roof, or controlling position lights (insofar as any are provided on the towers and/or other parts of the wind farm) depending on brightness, or automatically releasing or operating doors, or influencing the speed of the gondola, including bringing it to a stop.

In one alternative embodiment of the invention, the control system can be decentralised. To this end, separate control systems can be provided in at least two of the facilities on a wind farm, said systems communicating with each other and with the gondola. In this way, operating parameters and states can likewise be identified and analysed. Each control system can be connected with a predefinable portion of the sensors and/or actuators. One advantage of this decentralised solution is the redundancy thus provided, such that in the event of a control unit failure, neighbouring control units can take over its functions.

In one particularly advantageous development of the invention, support masts are provided between wind turbines on a wind farm in order to support the cable connection and in this way prevent excessive sag of the cable connection between the towers, as well as the loads that can ensue as a result of large spans between the towers of the wind turbines on a wind farm.

The wind farm according to the invention is preferably equipped with at least one accommodation area for accommodating at least one person. The space within said accommodation area is preferably organised into different functional areas, such as a sanitation area and/or a kitchen area and/or a pantry area and/or a rest area, and it is particularly preferable that it be integrated into the tower of a wind turbine.

In one alternative embodiment of the invention, the accommodation area is located separately from the wind turbines but within the wind farm. This location can be a separate platform, for example, or can preferably be on a platform mounted on a tower of a wind turbine.

Said platform can serve additional functions, such as those of a helicopter pad and/or a ship's berth.

Due to the limited area inside the tower, the accommodation area in a preferred development of the invention is distributed among several interconnected levels inside the tower. Within the accommodation area, equipment for communicating and signalling predefined data is provided. Said signalling may include acoustic and optical signalling, or an appropriate way of recording the data.

Communication includes voice and/or data communication on wire or wireless communication links, on the one hand with remote stations outside the wind farm, such as remote operations or maintenance centres, and on the other hand with remote stations inside the wind farm, such as other wind turbines or the gondola of the cable car system.

In a particularly preferred embodiment of the invention, communication also includes influencing predefined operating parameters of the wind farm facilities, as well as surveillance and control of wind farm operation. By this means, a continuously manned monitoring station can be created on the wind farm according to the invention, said monitoring station being able to respond immediately in the event of faults or failures occurring, and can take or initiate appropriate counter-measures.

In one particularly preferred development of the invention, a water treatment plant for supplying the personnel with drinking water and service water is provided, said plant being operated with electrical energy generated on the wind farm. To bridge gaps in supply due, for example, to windless conditions, a suitably dimensioned energy storage means is provided to ensure that emergency operations at least are maintained in order to continue supplying the accommodation area with energy and water.

The energy storage means used for this purpose can be storage means for electrical power, such as capacitors, chemical means of energy storage, such as accumulators, or storage means for hydrogen which are charged with hydrogen obtained from seawater by electrolysis, and from which electrical energy can be obtained in a fuel cell.

In one particularly preferred embodiment of the invention, at least the wind turbine equipped with the accommodation area includes equipment for weather observation, and/or for detecting, analysing, recording and/or forwarding meteorological data. Furthermore, the wind turbine or additional (all) wind turbines in the wind farm can perform functions as navigational aids for shipping, for example in the form of a sea marker or as a station for providing (first) aid to persons involved in accidents, or to shipwrecked persons.

In one development of the invention, at least one wind turbine equipped with an accommodation area has a viewing platform provided on the tower of the wind turbine below the machine house. Said viewing platform can encircle the tower of the wind turbine either completely, or at least partially in a preferred direction, and be fitted with windows that enable the surrounding area to be monitored. Said viewing platform can also be equipped with devices for signalling data, for influencing predefined operating parameters and/or for communication. The wind turbine with the viewing platform is positioned within the wind farm in such a way that a maximum number (preferably all) of the wind turbines in the wind farm can be seen from that position.

The viewing platform can be provided in close physical proximity to the accommodation area, or form an integral part thereof. Alternatively, the viewing platform and the accommodation area can be spatially separated, with the accommodation area located below the viewing platform near the base of the tower in order to permit more generous dimensions of the rooms, whereas the viewing platform is located immediately below the machine house to enable good observation of the surroundings.

If the distance between the viewing platform and the accommodation area is large, an elevator can be provided inside the tower to save time when making several trips a day between the viewing platform and the accommodation area, on the one hand, and to limit the physical burden on the personnel, on the other hand. The elevator can be equipped with an emergency telephone facility so that help can be called in the event of the elevator breaking down.

### BRIEF DESCRIPTION OF THE DRAWINGS

FIG. 1 a first embodiment of the cable system on a wind farm;

FIG. 2 a second embodiment of the cable system on a wind farm;

FIG. 3 a third embodiment of the cable system on a wind farm;

FIG. 4 the path of the cable connection between two wind turbines;

FIG. 5 an alternative cable arrangement;

FIG. 6 is an enlarged portion of FIG. 5 showing a suspension and drive of the gondola by means of a main cable and a traction cable;

FIG. 7 a plan view of a wind turbine tower with a protective roof for the gondola; and

FIG. 8 a side elevation view of the tower with the protective roof from FIG. 7.

### DETAILED DESCRIPTION OF THE INVENTION

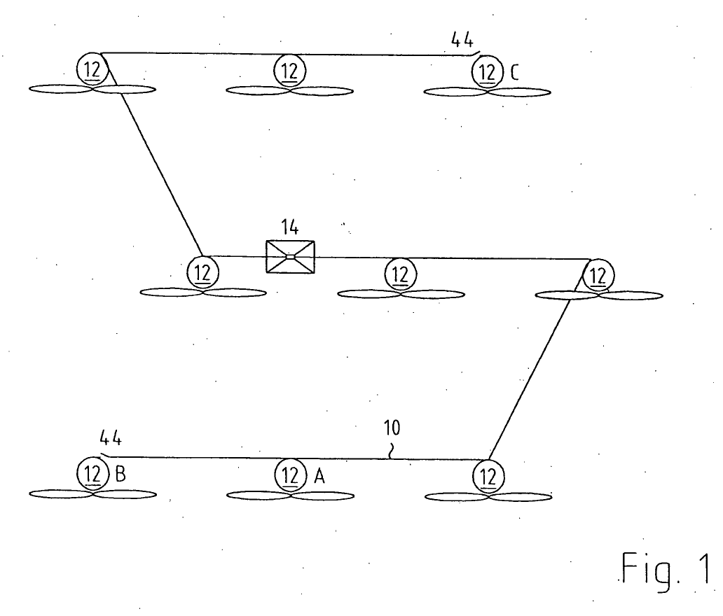

FIG. 1 shows a wind farm comprising nine wind turbines 12. Said wind turbines 12 are arranged in three rows, each comprising three wind turbines 12 and connected with each other by a cable connection 10 in such a way that the gondola 14 can reach the separate wind turbines 12 separately and consecutively. Thus, when travelling from one end of the cable connection 10 to the other end of the cable connection 10, the gondola 14 always passes all the wind turbines 12 on the wind farm.

The cable connection 10 can be an endless cable loop on which the gondola 14 is fixedly disposed. Therefore, when the cable moves, the gondola 14 is inevitably moved as well.

If the endless cable loop lies in a substantially horizontal plane, the cable can be driven in a constant direction at all times, in the simplest case, and the gondola 14 moves in the opposite direction after passing the deflection point, thereby being shifted by the horizontal dimension of the endless cable loop.

However, since this also applies when travelling from one wind turbine 12 to an adjacent wind turbine 12 in the opposite direction, it may be necessary to pass all the other wind turbines of the wind farm such that the gondola must travel almost twice the length of the cable connection 10.

For example, if the gondola 14 is located at the wind turbine marked A and must now travel to the wind turbine marked B, it must first travel, in the case of a unidirectional cable drive, to the wind turbine marked C and from there back to the destination wind turbine marked B. In doing so, it travels the entire length of the cable connection almost twice.

If it is possible to drive the cable connection in two directions, all that is needed for the trip from A to B is a reversal of the direction of travel and a short trip between two wind turbines.

If the cable connection 10 is an endless cable connection in a substantially vertical plane, a means for driving the cable connection 10 in two directions is absolutely essential, since otherwise the gondola fixedly attached to the cable connection 10 would get into a hazardous situation at the latest on reaching the reversal point on the endless cable loop.

For this reason, sensors 44 are provided on the wind turbines marked B and C in the figure, wherein said sensors identify when their position is reached by the gondola 14, and thus initiate a stop or redirection procedure. For the sake of simplicity, these sensors are shown as switches. Other types of sensor, such as Hall sensors, optical sensors, etc., are also suitable, of course, for determining whether the gondola 14 has reached this position. Of course, the position of the sensors is chosen so that there is still sufficient stopping distance even when the gondola 14 is loaded.

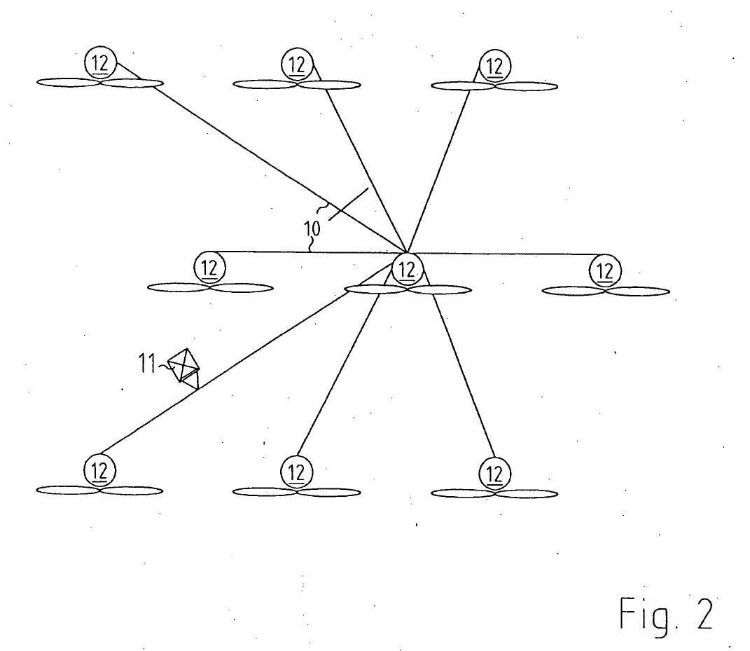

FIG. 2 likewise shows a wind farm comprising nine wind turbines 12 arranged in three rows each with three wind turbines 12. In this arrangement, there is a central wind turbine 12 that can have special docking and storage facilities, for example. Radiating from this central wind turbine 12, there is a star-shaped arrangement of cable connections 10 connecting to all the other wind turbines 12 of the wind farm. This results in the shortest possible paths for the gondola 14 (not shown in this figure) to reach the other wind turbines 12—each measured from the central wind turbine 12.

However, a trip from one of the non-central wind turbines 12 to another non-central wind turbine 12 always leads firstly to the central wind turbine 12 and onwards from there to the destination wind turbine 12.

Also shown in this figure is a support mast 11 at a cable connection 10. Said support mast 11 supports the cable connection 10, thus preventing excessive sag of the cable connection 10 in the case of large spans between two wind turbines 12.

This sag results from the cable connection's own weight. Depending on the properties of the cable connection 10, there is a maximum distance between two support points for the cable connection 10, which if exceeded may result in the cable connection 10 severing under its own weight. However, even with a lower spacing between the support points, the sag in the cable connection 10 may already be too great, causing the gondola 14 to come too close to the water surface.

This could be counteracted, theoretically, by having a higher tension in the cable connection 10. However, if a higher tension in the cable connection arises due to the effect of cold temperatures, the tensile strength may be exceeded and the cable connection 10 will sever. In other words, depending on the material used, a certain amount of sag in the cable connection 10 is unavoidable. However, these problems can be solved by using support masts 11.

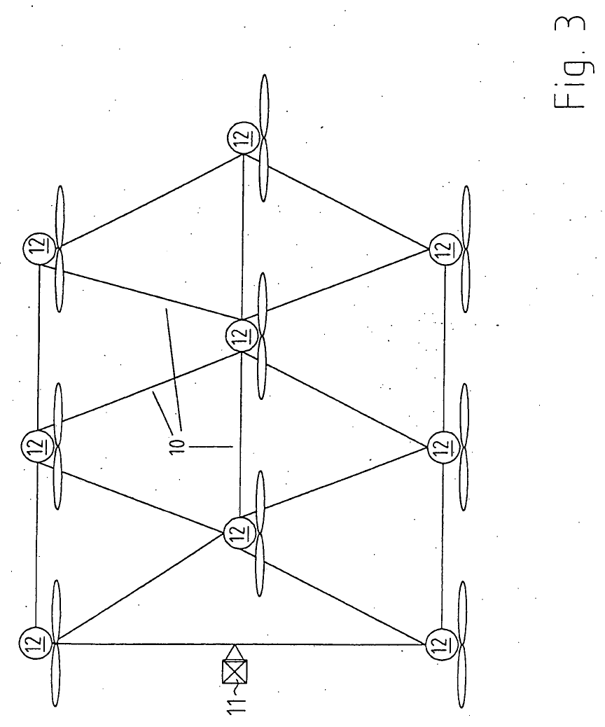

FIG. 3 shows the same arrangement of wind turbines 12 as in FIGS. 1 and 2. The difference again consists in the structure of the cable connection 10 between the wind turbines 12. In FIG. 3, the structure is like that of a network, such that each wind turbine 12 forms a node in the network. By means of this cable structure, even shorter distances ensue for particular stretches over which the gondola 14 (not shown in the figure) can reach particular wind turbines 12.

In this figure, too, a support mast 11 is provided for a large span between two wind turbines 12 in order to limit the sag and the tension in the cable connection 10. Of course, support masts 11 can be used in any segment of the cable connection 10 between two wind turbines 12, in order to gain additional support points for the cable connection 10.

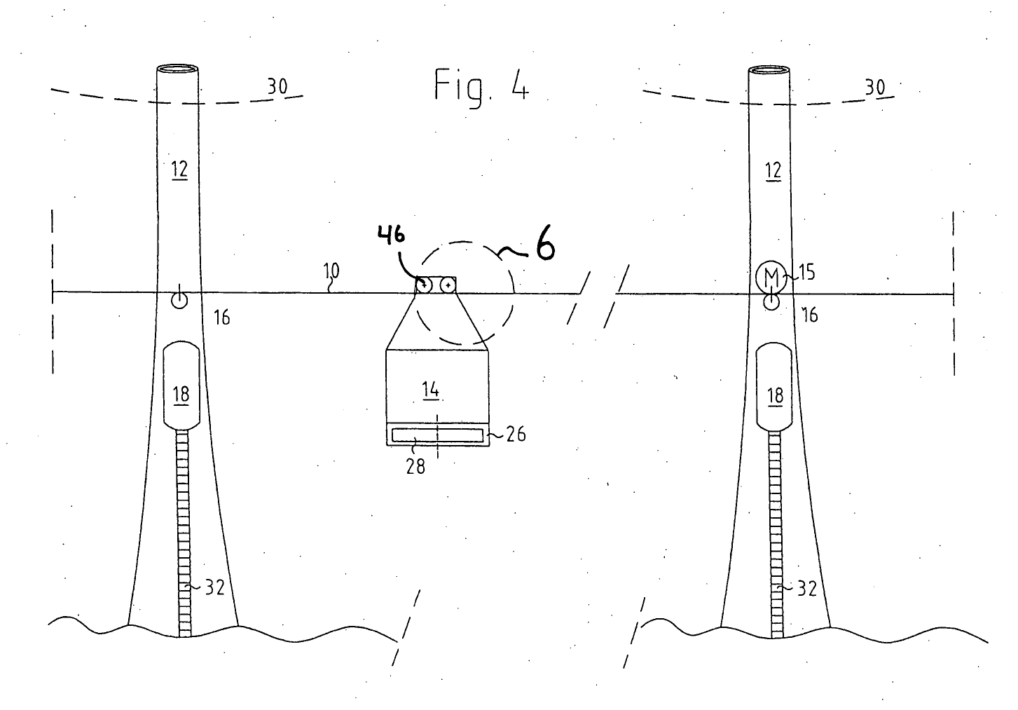

FIG. 4 shows two wind turbines 12 that are connected with each other by a cable connection 10. The upper portions of the towers have been left out in the figure, although the lower edge of the area swept by the rotors is shown by a broken line 30. Each of the towers has an opening 18 that can be closed with a door, and from each opening a ladder 32 is provided that leads to the base of the tower. The opening 18 in the tower is provided at the height at which the gondola 14 reaches the tower.

Above the opening 18 on each tower, a deflection member 16 is provided through which the cable connection 10 is guided. The gondola 14 is located on said cable connection 10. Depending on the embodiment of the cable connection 10, the gondola 14 is carried and/or driven by the cable connection, or the gondola 14 moves under its own power along the cable connection 10.

In the example shown, a drive motor 15 is located on the tower of a wind turbine above the deflection pulley 16, said drive motor being able to drive the cable connection 10 in appropriate manner in the case of a gondola 14 that is not self-propelled.

In the lower part of the gondola 14 there is an additional compartment 26 that is separated from the gondola cabin by the floor of the latter. Inside said compartment 26 there is a flywheel mass 28 which by means of a drive motor is kept at a high speed of rotation about its rotational axis, shown as a broken line. As a result of this rotation, the flywheel mass 28 acts as a gyroscope and stabilizes the gondola 14 in its position by counteracting any horizontal displacement on the part of the gondola 14. By this means, the gondola 14 is stabilized while travelling and displaced to only a limited extent, even when cross winds occur.

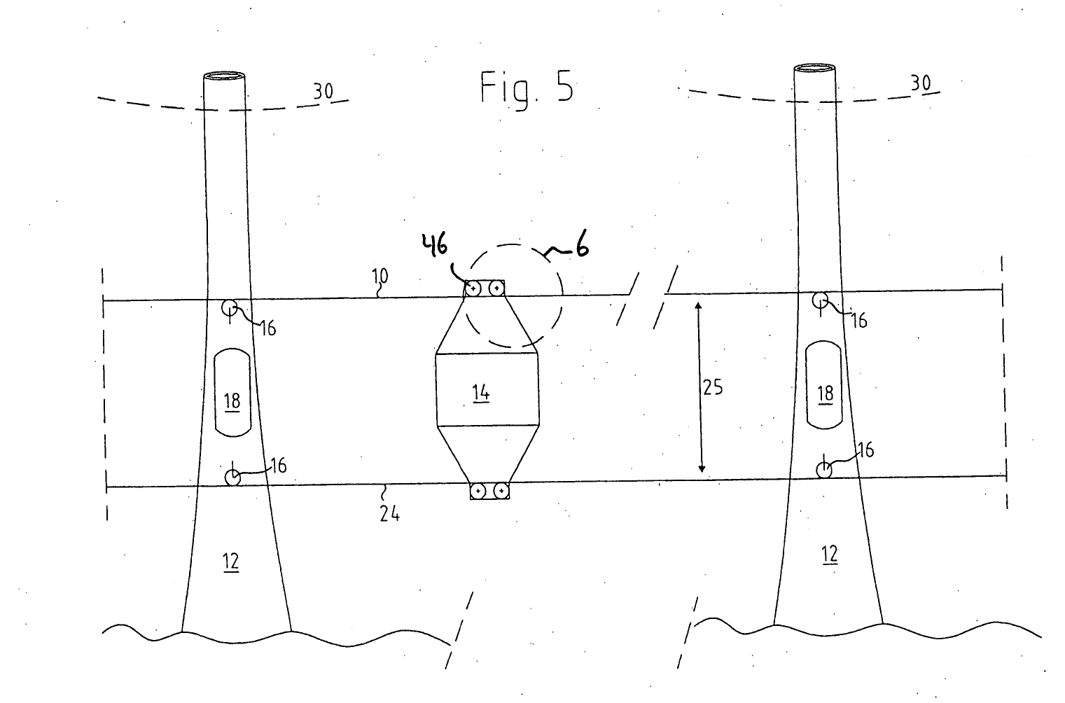

The drawing in FIG. 5 likewise shows two towers of wind turbines 12, the upper portions of which have been omitted from the figure. However, the lower portion of the area swept by the rotors is again shown. In the towers, the closeable openings 18 are shown at the height at which the gondola reaches the wind turbine 12.

Above the opening 18 there are deflection members 16 through which the cable connection 10 is guided. The gondola 14 is disposed on said cable connection 10 and can be made to travel between the wind turbines.

Deflection members 16 are also provided below the openings 18. By means of these additional deflection members 16, a further cable connection in the form of a holding cable 24 is guided. Said holding cable 24 runs at a predefined vertical distance 25 parallel to the cable connection 10 and guides the gondola 14. By this means, the horizontal excursion of the gondola 14 is limited, because it is guided both above and below by cables 10, 24.

The potential horizontal displacement of the gondola 14 varies according to the distance to the next wind turbine 12. When the distance between gondola 14 and wind turbine 12 decreases, the stabilising effect of deflection members 16 increases, and the potential horizontal displacement of the gondola 14 is accordingly lower, whereas when the distance between the gondola 14 and a wind turbine 12 increases, the amount of sag in the cable connection 10 and the holding cable 24 increases. In the middle of the stretch between two wind turbines 12, the sag is at its greatest, and hence the potential horizontal displacement of the gondola 14 is at its maximum.

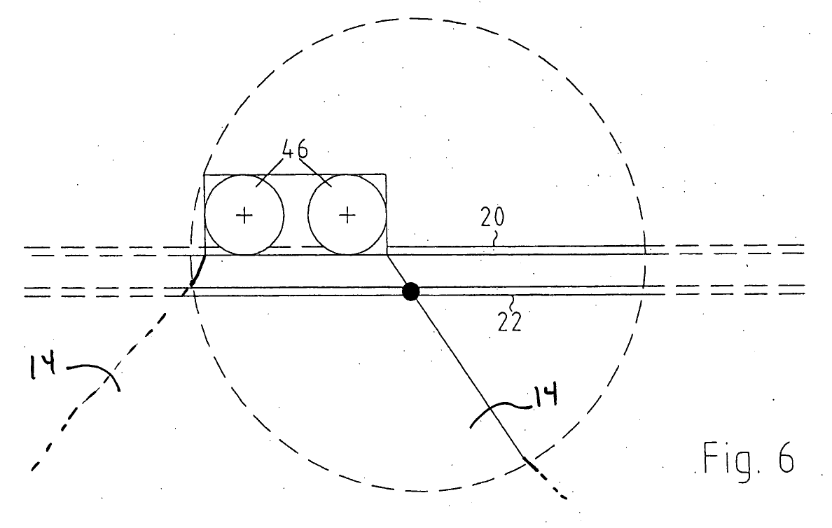

FIG. 6 shows an enlarged view of the portions enclosed by a broken circular line in FIG. 4 and FIG. 5. The cable connection 10 is formed by two cables 20, 22. The upper cable 20 is provided as a main cable and carries the gondola 14 which is moveably disposed thereon with two guide sheaves 46. The lower cable 22 is a traction cable and is fixedly attached to the gondola 14. By operating said traction cable 22, the gondola 14 can be moved in a suspended position along the main cable.

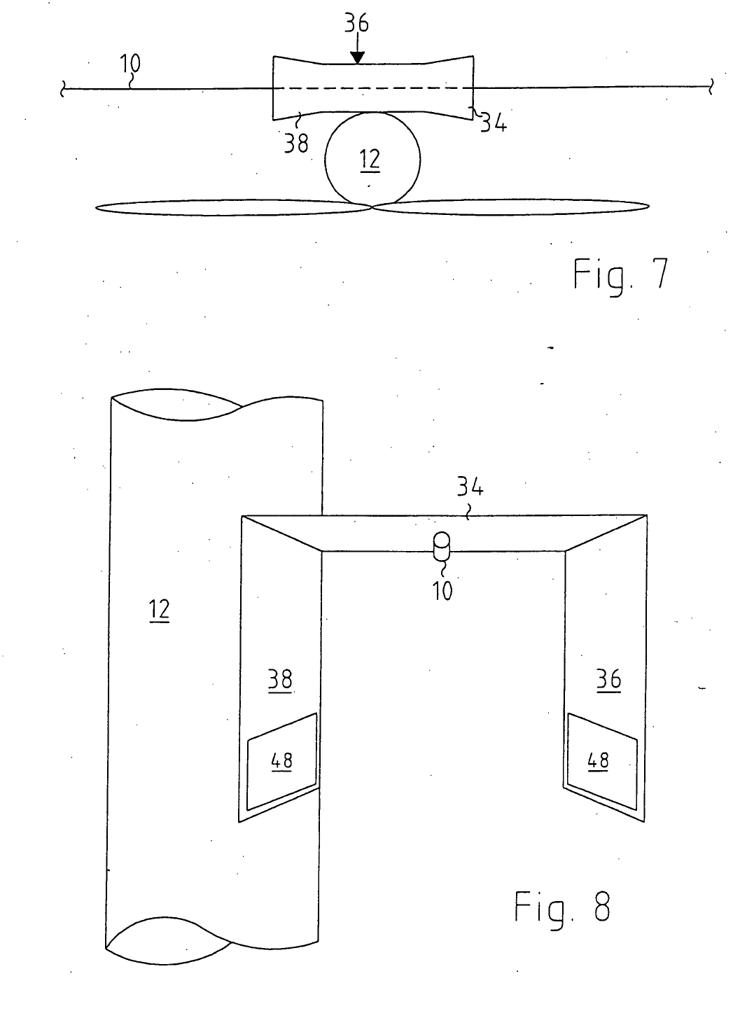

FIGS. 7 and 8 show a wind turbine 12 (FIG. 7) and a portion of the tower of the wind turbine 12 (FIG. 8) with a cover 34 of substantially horizontal extension disposed thereon. FIG. 7 is a plan view and FIG. 8 a side elevation view.

The cable connection 10 runs below said cover 34; the means by which it is suspended is not shown here for the sake of a better overview. Protective walls 36 are disposed on each of the two sides of the cover 34 that run parallel to the cable connection 10.

In combination with the cover 34, these protective walls 36 form a protective roof that protects the gondola 14 and the opening 18 in the tower of the wind turbine 12 against the weather. Said protective roof extends on both sides of the opening 18, parallel to the cable connection 10.

The outer ends of the protective roof are widened, due to the fact that, while the gondola is travelling between two wind turbines 12, horizontal displacement of the gondola 14 is possible at all times, albeit limited in amount and direction. The spacing between the protective walls 36 increases in predefined portions of the protective roof with increasing distance from the opening 18. In the middle portion, near the opening 18, the dimensions of the protective roof can be substantially equal to those of the gondola 14.

By means of the greater spacing between the protective walls 36, the gondola 14 can be moved between the protective walls and hence into their lee side, even when, for example, the gondola is horizontally displaced by cross winds. Owing to the shelter from the wind thus provided, the gondola 14 is no longer displaced and for this reason the spacing between the protective walls 36, 38 can be made smaller.

Elastic coatings 48 are provided on the protective walls 36, 38 in the entry area, said coatings being intended to dampen any collision of the gondola 14 with the protective walls 36, 38 in such a way at least that no significant damage occurs. Independently of these coatings 48 on the protective walls 36, 38, similar coatings can be provided on the gondola, for example in the form of fenders.

Another embodiment of a wind farm according to the invention, has an offshore platform and the wind turbines of the wind farm. For the sake of simplicity, the cable connection between the wind turbines themselves are not shown (see FIG. 3 or FIG. 2 instead). There is a cable connection between the offshore platform and at least one wind turbine that is centrally allocated in the wind farm to the platform. Another possible configuration (see FIG. 2) is a star-shaped arrangement of the cable connection between the platform and the wind turbines, wherein the platform then forms the centre of the star-shaped network.

As on previously known offshore oil-drilling platforms, all the facilities enabling people to stay on the platform for extended periods can be accommodated on the platform. These include, in particular, living quarters, sleeping quarters, mess rooms and all other facilities that also enable the wind farm maintenance and operating personnel to stay for several weeks at a time.

In addition, the platform itself can be equipped with electrolysis equipment (this can also be provided on a separate platform) so that water can be converted electrolytically into its constituent elements, oxygen and hydrogen, using the power generated by the wind turbines of the wind farm. Both gases, in any case the hydrogen gas, is then stored in gas tanks provided in the platform or separately thereto, or the gas produced is conveyed to land by means of pipelines. When the gas is stored on the platforms, it can be collected by suitable transport ships.

The special advantage of such hydrogen production is that fluctuating power generation due to varying wind conditions is of no concern, because the gas tanks provide an adequate buffer that permits continuous transportation of gas despite fluctuating production output.

Given that the production of hydrogen from water makes sense only if renewable energy is used, a very large production capacity can be provided with the wind farm, because the electrical power output of the wind farm is in the order of several megawatts, and preferably in excess of 500 MW.

The platforms themselves are also so large, generally, that they are fitted with a special helicopter landing pad, such that people can be transported to the wind farm by helicopter and that the helicopters can land relatively safely on the platforms on account of their substantial size.

The cableway connection of the invention between the platforms and at least one wind turbine also has the advantage that, in the event of an accident on the residential platform, the personnel can still move to the wind turbine, where it is firstly in safety.

In order to avoid any collision between passing ships and the gondola, the gondolas and/or the cables are also fitted with an anti-collision light that is switched on unavoidably on at least one moving gondola, thus attracting a very high level of attention on the part of any passing ships.

It is also possible to provide technical facilities that permit the gap between the gondola and an obstruction to be detected, i.e., using radar or ultrasound.

In order to receive a certain advance warning, the boundaries of the wind farm or sections of the wind farm, for example, can also be monitored for entry of a watercraft. This can be effected with visual monitoring means, or with radar equipment or the like. In combination with such a means, a forced control can be activated when a ship is detected entering the wind farm, wherein said control forces the gondolas to travel to the nearest wind turbine, so that any collision can be safety prevented. At the same time, standard warning messages can be transmitted to the ship's bridge over certain radio channels, such as the emergency channel, warning them of the hazard.

In order to help sailors or water sportspeople after an accident at sea using the gondolas, the gondolas can also be equipped with safety equipment such as jack ladders, winches for rescue seats or the like, and first-aid equipment or similar.

The platform can also be a life-saver for people shipwrecked in the area of the wind farm, in particular when an injured or freezing person on the high seas can be taken care of on the platform to such an extent that initial recovery can occur. It is advantageous in this context if there is basic medical equipment and supplies on the platform, so that primary or minimum medical treatment can be assured.

From the foregoing it will be appreciated that, although specific embodiments of the invention have been described herein for purposes of illustration, various modifications may be made without deviating from the spirit and scope of the invention.

1. An offshore wind farm comprisign:
at least one offshore platform within the wind farm, said platform being suitable for providing the living and accommodation space for the personnel operating the wind farm;
a cable connection being provided between said platform and at least one wind turbine of the wind farm; and
a gondola hanging on said cable connection for travelling from said platform to said wind turbine.

2. The wind farm according to claim 1,
characterized in that a spare parts depot for the most important wearing parts of the wind turbine is provided on the offshore platform and that said parts are transported to the wind turbines via the cableway connection.

3. The wind farm according to claim 1,
characterized in that the platform is equipped with an electrolysis plant that is supplied with electrical power by the wind turbines, wherein hydrogen and oxygen are produced from water by means of electrolysis.

4. The wind farm according to claim 3,
characterized in that the offshore platform has one or more gas tanks in which the gas produced (H₂; O₂) is stored.

5. The wind farm according to claim 1,
characterized by at least two wind turbines and a cable connection spanning at least two wind turbines at a predetermined height, and a gondola disposed on said cable connection.

6. The wind farm according to claim 5,
characterized by a cable connection spanned as an endless cable between deflection members at the wind turbines and/or the platform and by a rigid connection between the cable connection and the gondola.

7. The wind farm according to claim 5,
characterized by a cable connection comprising a main cable and a traction cable and a gondola, the gondola being moveably connected to the main cable and fixedly connected to the traction cable.

8. The wind farm according to claim 7,
characterized by a traction cable extending as an endless loop along the deflection members.

9. The wind farm according to claim 7,
characterized by a deflection member with two independently rotatable deflection pulleys.

10. The wind farm according to claim 7,
characterized by the traction cable being driven by a motor.

11. The wind farm according to claim 5,
characterized by a gondola that moves along the cable connection under its own power.

12. The wind farm according to claim 11,
characterized by at least one motoric drive for moving the gondola along the cable connection, wherein the drive is preferably an electrical drive.

13. The wind farm according to claim 12,
characterized by the gondola drive receiving a drive power supply from a store of energy carried in the gondola.

14. The wind farm according to claim 11,
characterized by at least one manually operable drive for moving the gondola along the cable connection.

15. The wind farm according to claim 11,
characterized by a remotely controllable drive for moving the gondola.

16. The wind farm according to claim 15,
characterized by use of at least one portion of the cable connection as an electrical conductor.

17. The wind farm according to claim 16,
characterized by a cable which is integrated into the cable connection.

18. The wind farm according to claim 5,
characterized by a star-shaped arrangement of cable connections between a specified wind turbine and the other wind turbines.

19. The wind farm according to claim 5,
characterized by a networked arrangement of cable connections between the wind turbines, wherein each wind turbine forms a node in the network.

20. The wind farm according to claim 5,
characterized by a single cable connection between the wind turbines of the wind farm, said cable connection connecting at least one portion of the wind turbines in a predeterminable sequence.

21. The wind farm according to claim 18,
characterized by a combination of at least two of the aforesaid systems of cable connections.

22. The wind farm according to claim 1,
characterized by a detachable locking device between the gondola and the tower of a wind turbine.

23. The wind farm according to claim 22,
characterized by a locking device in the form of a holding magnet.

24. The wind farm according to claim 1,
characterized by a holding cable extending parallel to the cable connection at a predefined distance therefrom.

25. The wind farm according to claim 1,
characterized by a cable connection extending at a predefined horizontal distance from the tower of the wind turbine, and/or by a holding cable extending at a predefined horizontal distance from the tower.

26. The wind farm according to claim 24,
characterized by deflection members on the wind turbines for accommodating the holding cable.

27. The wind farm according to claim 24,
characterized in that the cable connection is configured as an endless cable loop, and that the holding cable is part of said endless cable loop.

28. The wind farm according to claim 1,
characterized by a gondola with a flywheel mass rotating about a vertical axis.

29. The wind farm according to claim 1,
characterized by a closeable opening in the tower of a wind turbine at the height at which the gondola reaches the tower.

30. The wind farm according to claim 29,
characterized by a locking device at the height of the gondola near the opening.

31. The wind farm according to claim 1,
characterized by a cover of substantially horizontal extension disposed above the opening on the tower of at least one wind turbine.

32. The wind farm according to claim 31,
characterized by a first protective wall disposed on the side of the cover facing away from the tower, said protective wall extending substantially vertically and at a predefined distance parallel to the cable connection.

33. The wind farm according to claim 1,
characterized by at least one second protective wall disposed at the tower of the wind turbine at the height of the opening and extending substantially parallel to the cable connection.

34. The wind farm according to claim 33,
characterized by a two-part second protective wall extending a predefined length on both sides of the opening.

35. The wind farm according to claim 32,
characterized by a gap between the first protective wall and the second protective wall, said gap increasing in size in a predefined portion at a distance from the opening.

36. The wind farm according to claim 32,
characterized by an elastic coating of predefined thickness on at least one of the protective walls.

37. The wind farm according to claim 31,
characterized by at least one lighting installation on the cover and/or the protective walls.

38. The wind farm according to claim 1,
characterized by at least one gangboard extending substantially parallel to the cable connection, said gangboard being reachable from the opening and having at least one retention facility along its entire length.

39. The wind farm according to claim 1,
characterized by a single- or multi-part working platform on the outside of the tower of at least one wind turbine, wherein said platform can be reached from the opening.

40. The wind farm according to claim 1,
characterized by a crown safety platform or a working cage outside the tower of at least one wind turbine, wherein said platform or cage can be reached from the opening.

41. The wind farm according to claim 1,
characterized by at least one first guide rail disposed on the tower of the wind turbine close to the opening and extending substantially parallel to the cable connection.

42. The wind farm according to claim 41,
characterized by a second guide rail extending at a predefined distance substantially parallel to the first guide rail.

43. The wind farm according to claim 41,
characterized by a gap between the first guide rail and the second guide rail, said gap increasing in size in a predefined portion at a distance from the opening.

44. The wind farm according to claim 41,
characterized in that the guide rails support the protective walls.

45. The wind farm according to claim 29,
characterized in that the closeable opening is larger than the gondola and the cable connection extends through the opening into the inside of the tower of the wind turbine.

46. The wind farm according to claim 1,
characterized by at least one set of points at each tower along the cable connection.

47. The wind farm according to claim 1,
characterized by load anchoring facilities and lashing means in the gondola.

48. The wind farm according to claim 1,
characterized by a hoisting device located on or in the gondola for handling the load being carried.

49. The wind farm according to claim 1,
characterized by a hoisting and/or transportation apparatus at or in the tower of at least one wind turbine.

50. The wind farm according to claim 1,
characterized by a gondola with an enclosed gondola cabin.

51. The wind farm according to claim 1,
characterized by an elastic coating at at least one location on the gondola where the risk of collision with other wind farm facilities is greatest.

52. The wind farm according to claim 1,
characterized by a buoyant gondola.

53. The wind farm according to claim 1,
characterized in that the elastic coating serves simultaneously as a float.

54. The wind farm according to claim 1,
characterized by a control device comprising a central control unit, sensors and/or actuators.

55. The wind farm according to claim 54,
characterized by the central control unit being disposed in one of the wind turbines of the wind farm.

56. The wind farm according to claim 54,
characterized by at least one sensor that detects when the gondola passes by.

57. The wind farm according to claim 1,
characterized by a GPS module disposed in the gondola.

58. The wind farm according to claim 1,
characterized in that electrical energy generated in the wind farm is used to power the electrical drives.

59. The wind farm according to claim 58,
characterized in that the energy is selectively drawn at the generator, at an intermediate DC circuit or at some other suitable point.

60. The wind farm according to claim 1,
characterized in that energy is transported within the wind farm at least partially in a form other than electricity.

61. The wind farm according to claim 1,
characterized by masts disposed adjacently between the towers of the wind turbines for supporting the cable connection.

62. A method for controlling the cable car system provided between at least two wind turbines of a wind farm,
characterized by evaluation by the central control unit of the situation as detected by the sensors, and the triggering of appropriate control signals for the actuators.

63. The method according to claim 62,
characterized by the transmission to the central control unit of GPS data and/or data in other encoded form indicating the position of the gondola.

64. The wind farm according to claim 1,
characterized by least one wind turbine having an accommodation area for accommodating at least one person.

65. The wind farm according to claim 64,
characterized by the accommodation area being equipped with a sanitary area and/or a kitchen area and/or a pantry area and/or a rest area.

66. The wind farm according to claim 64,
characterized by the accommodation area being integrated in the tower of a wind turbine.

67. The wind farm according to claim 64,
characterized by the accommodation area being arranged in a plurality of interconnected levels.

68. The wind farm according to claim 64,
characterized by a device for signalling predefined data and/or a device for influencing predefined operating parameters within the accommodation area.

69. The wind farm according to claim 64,
characterized by a communications facility for exchanging information and/or data.

70. The wind farm according to claim 64,
characterized by a water treatment plant for supplying the personnel with drinking water and service water.

71. The wind farm according to claim 64,
characterized by characterized by energy storage means for storing energy to bridge gaps in power supply.

72. The wind farm according to claim 64,
characterized by devices for weather observation, and/or for detecting, analysing, recording and/or forwarding meteorological data.

73. The wind farm according to claim 64,
characterized in that at least the wind turbine with the accommodation area has navigational aids for shipping and/or equipment for helping injured or shipwrecked persons.

74. The wind farm according to claim 64,
characterized by a viewing platform on the tower of the wind turbine in which the accommodation area is located, said viewing platform encircling the tower below the machine house either completely, or at least partially in a preferred direction.

75. The wind farm according to claim 74,
characterized in that at least part of the viewing platform has windows to enable the surroundings of the wind turbine to be monitored.

76. The wind farm according to claim 74,
characterized by an elevator between the accommodation area and the viewing platform.

77. The wind farm according to claim 64,
characterized in that the platform is a discarded/used oil or gas drilling platform.
